(19) United States
(12) Patent Application Publication
(10) Pub. No.: US 2024/0138452 A1
(43) Pub. Date: May 2, 2024

(54) SEASONING BLEND CONTAINING TETRAHYDROCANNABINOL

(71) Applicant: Tanya Diaz, Charlotte, NC (US)

(72) Inventor: Tanya Diaz, Charlotte, NC (US)

(21) Appl. No.: 18/385,671

(22) Filed: Oct. 31, 2023

Related U.S. Application Data
(60) Provisional application No. 63/381,840, filed on Nov. 1, 2022.

(51) Int. Cl. A23L 27/20; A23L 27/10; A23L 27/16

(52) U.S. Cl. CPC A23L 27/2052; A23L 27/105; A23L 27/16

(57) ABSTRACT

A seasoning blend containing tetrahydrocannabinol is designed and configured to provide a seasoning blend, a seasoning mixture and a method of seasoning a food ingredient and/or a food product with tetrahydrocannabinol. The seasoning blend is designed and configured to provide a seasoning blend and/or a seasoning mixture that contains tetrahydrocannabinol. The seasoning blend is configured for the use of tetrahydrocannabinol in reducing the content of common salt, and/or sodium chloride in a food ingredient or a food product. The seasoning blend is designed and configured to reduce stress and encourage healthy sleep without the use of sleeping aids. In select embodiments, the seasoning blend includes a legalized synthetic form of a delta-8 tetrahydrocannabinol, a delta-9 tetrahydrocannabinol, a delta-10 tetrahydrocannabinol, or a combination thereof and additional ingredients. The ingredients of the seasoning blend may be prepared with a food grinder and/or stored in a 1 oz-3 oz plastic seasoning container.

### CROSS-REFERENCE TO RELATED APPLICATIONS

This application claims benefit to U.S. Provisional Patent Application No. 63/381,840, filed on Nov. 1, 2022, which is incorporated by reference in its entirety.

### FIELD OF THE DISCLOSURE

The present disclosure is related to seasonings for foods and/or beverages. More specifically, the present disclosure may be related to a seasoning blend for foods and/or beverages containing tetrahydrocannabinol, also known as THC.

### BACKGROUND

Generally speaking, seasoning is the process of supplementing food via herbs, spices, salts, and/or sugar, intended to enhance a particular flavor. Seasonings include herbs and spices, which are themselves frequently referred to as seasonings. As an example, salt may be used to draw out water, or to magnify a natural flavor of a food making it richer or more delicate, depending on the dish. This type of procedure is akin to curing. For instance, sea salt (a coarser-grained salt) is rubbed into chicken, lamb, and beef to tenderize the meat and improve flavor. Other seasonings like black pepper and basil transfer some of their flavors to the food. A well-designed dish may combine seasonings that complement each other. Seasonings are usually added near the end of the cooking period, or even at the table, when the food is served. The most common table-seasonings are salt, pepper, and acids such as lemon juice. When seasonings are used properly, they cannot be tasted. Instead, the desire of most seasonings is to heighten the flavors of the original ingredients.

Seasoning blends or spice mixes are blended spices or herbs. When a certain combination of herbs or spices is called for in a recipe, it is convenient to blend these ingredients beforehand. Blends such as chili powder, curry powder, herbes de Provence, garlic salt, and other seasoned salts are traditionally sold pre-made by grocers, and sometimes baking blends such as pumpkin pie spice are also available. These spice mixes are also easily made by the home cook for later use.

Current seasoning blends are typically high in salt or sodium chloride. But too much sodium in the diet can lead to high blood pressure, heart disease, and stroke. It can also cause calcium losses, some of which may be pulled from bone. Most Americans consume at least 1.5 teaspoons of salt per day, or about 3400 mg of sodium, which contains far more than our bodies need. As such, there is clearly a need to provide a seasoning blend that is low in salt.

In addition, none of the current seasoning blends or spice mixes are designed and/or configured to reduce stress and/or encourage healthy sleep without the use of sleeping aids or over the counter sleeping medicines or drugs. As such, there is clearly a need to provide a seasoning blend that is designed to reduce stress and/or encourage healthy sleep without the use of sleeping aids or over the counter sleeping medicines or drugs.

The instant disclosure may be designed to address at least certain aspects of the problems or needs discussed above by providing a seasoning blend for foods and/or beverages containing tetrahydrocannabinol (“THC”).

### SUMMARY

The present disclosure may solve the aforementioned limitations of the currently available seasoning and/or seasoning blends by providing a seasoning blend containing tetrahydrocannabinol. The disclosed seasoning blend containing tetrahydrocannabinol may be designed and/or configured to provide a seasoning blend, a seasoning mixture and a method of seasoning a food ingredient and/or a food product with tetrahydrocannabinol. The seasoning blend may be designed and/or configured to provide a seasoning blend and/or a seasoning mixture that contains tetrahydrocannabinol. The seasoning blend may be configured for the use of tetrahydrocannabinol in reducing the content of common salt, and/or sodium chloride in a food ingredient or a food product. The seasoning blend may be designed and/or configured to reduce stress and encourage healthy sleep without the use of sleeping aids, i.e., over the counter sleeping drugs or medicines. In select embodiments, the seasoning blend may include a delta-8 tetrahydrocannabinol, a delta-9 tetrahydrocannabinol, a delta-10 tetrahydrocannabinol, or a combination thereof, and additional ingredients. The ingredients of the seasoning blend may be prepared with a food grinder and/or stored in a 1 oz-3 oz plastic seasoning container.

The foregoing illustrative summary, as well as other exemplary objectives and/or advantages of the disclosure, and the manner in which the same are accomplished, are further explained within the following detailed description and its accompanying drawings.

### DETAILED DESCRIPTION

In describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure may solve the aforementioned limitations of the currently available seasoning and/or seasoning blends by providing the disclosed seasoning blend containing tetrahydrocannabinol. The disclosed seasoning blend containing tetrahydrocannabinol may be designed and/or configured to provide a seasoning blend, a seasoning mixture and a method of seasoning a food ingredient and/or a food product with tetrahydrocannabinol. The disclosed seasoning blend may be designed and/or configured to provide a seasoning blend and/or a seasoning mixture that contains tetrahydrocannabinol, or the like. The disclosed seasoning blend may be configured for the use of tetrahydrocannabinol in reducing the content of common salt, and/or sodium chloride in a food ingredient or a food product. The seasoning blend may be designed and/or configured to reduce stress and/or encourage healthy sleep without the use of sleeping aids, i.e., over the counter sleeping drugs or medicines. In select embodiments, the seasoning blend may include tetrahydrocannabinol, and additional ingredients. The ingredients of the seasoning blend may be prepared with a food grinder and/or stored in a 1 oz-3 oz plastic seasoning container.

One feature of the disclosed seasoning blend may be that it includes tetrahydrocannabinol, also known as THC. Tetrahydrocannabinol may be a psychoactive cannabinoid found in the cannabis plant. Tetrahydrocannabinol, as used herein, may include any form of tetrahydrocannabinol, including, but not limited to, delta-8 tetrahydrocannabinol, delta-9 tetrahydrocannabinol, and/or delta-10 tetrahydrocannabinol. Delta-8 (delta-8-THC, 48-THC) may be an isomer of delta-9-tetrahydrocannabinol (delta-9-THC, Δ9-THC), the compound commonly known as THC. As such, the instant disclosure is not so limited to the use of just delta-8 THC, but may also include the use of delta-9 THC, delta-10 THC, or combinations thereof, for use in seasoning blends. The THC may be provided in flowers (or oils) and then may be grinded up with a grinder, or like mechanism, to a grinded up form. As such, the grinded up form may produce a powder, granular, or flour like substance.

The tetrahydrocannabinol used in the disclosed seasoning blend may be any form of tetrahydrocannabinol, or the like. In select embodiments of the disclosed seasoning blend, the tetrahydrocannabinol may be a legalized synthetic form of a delta-8 tetrahydrocannabinol, a delta-9 tetrahydrocannabinol, a delta-10 tetrahydrocannabinol, or a combination thereof in the grinded up form. As an example, and clearly not limited thereto, in select possibly preferred embodiments, the legalized synthetic form of the delta-8 tetrahydrocannabinol, the delta-9 tetrahydrocannabinol, the delta-10 tetrahydrocannabinol, or the combination thereof may be dronabinol in the grinded up form, like Marinol® (provided by Solvay Pharmaceuticals of Brussels, Germany), Syndros® (provided by Benuvia, Inc. of Round Rock Texas), Reduvo™ (provided by Tetra Bio-Pharma Inc of Ontario, Canada), Adversa® (provided by Tetra Bio-Pharma Inc of Ontario, Canada), the like, etc. in the grinded up form. The term legalized form of THC may be any current legalized amount of THC, or any future legalized amount of THC. As such, the term legalized amount of THC may very in the future whereby higher dosages and/or different forms or deltas (delta-8, delta-9 and/or delta-10) of THC may be used in the disclosed seasoning blend.

In select embodiments of the disclosed seasoning blend, the tetrahydrocannabinol in the grinded up form may be derived from a cannabis flower. The cannabis flower may be a cannabis flower that is harvested, dried, and cured. The cannabis flower may be a synthetic cannabis flower. In select embodiments, the cannabis flower may include approximately 20.4% total cannabinoids, or equal to 20.4% or 20.376%. Of these total cannabinoids in the cannabis flower, approximately 0.5% total may be tetrahydrocannabinol, or equal to 0.5% or 0.493%. In select embodiments, the cannabis flower may include: less than the limit of quantitation percentage of delta-9 tetrahydrocannabinol; 0.562% mass of delta-9 tetrahydrocannabinolic acid; less than a limit of quantitation percentage of cannabidivannic acid; 0.991% mass of cannabidiol; 17.617% mass of cannabidiolic acid; 0.310% mass of cannabigerolic acid; 0.075% mass of cannabichromene; and 0.819% mass of cannabichromenic acid. In addition, the cannabis flower may have lower than a limit of detection of: delta-8 tetrahydrocannabinol; delta-9 tetrahydrocannabiphorol; delta-9 tetrahydrocannabivarin; delta-9 tetrahydrocannabivarinic acid; R-delta-10 tetrahydrocannabinol; S-delta-10 tetrahydrocannabinol; 9R-hexahydrocannbinol; 9S-hexahydrocannbinol; tetrahydrocannabinol acetate; cannabidavarin; cannabigerol; cannabinol; and cannabinolic acid. Wherein, the limit of quantitation percentage being 0.0714% and the limit of detection being 0.0476%. These amounts or the composition of the cannabis flower may be according to testing method HPLC, CON-P-3000. In select embodiments, the cannabis flower may be a cured sour candy kush plant.

The disclosed seasoning blend may include various amounts of the tetrahydrocannabinol as desired. In select embodiments, the disclosed seasoning blend may include between 1% and 25% of a total weight of the seasoning blend of the tetrahydrocannabinol in the grinded up form. In select possibly preferred embodiments, the disclosed seasoning blend may include between 5% and 20% of the total weight of the seasoning blend of the tetrahydrocannabinol in the grinded up form. In select possibly more preferred embodiments, the disclosed seasoning blend may include between 10% and 15% of the total weight of the seasoning blend of the tetrahydrocannabinol in the grinded up form. In select possibly most preferred embodiments, the disclosed seasoning blend may include approximately 11% of the total weight of the seasoning blend of the tetrahydrocannabinol in the grinded up form.

The disclosed seasoning blend may also include additional ingredients beyond the tetrahydrocannabinol, as desired. The additional ingredients used in the disclosed seasoning blend beyond the tetrahydrocannabinol may be any desired additional ingredients for a seasoning blend. In select embodiments, the additional ingredients may include, but are not limited to: petrified onions; a salt; a corn starch; a sugar; a monosodium glutamate; a dried basil; a dried oregano; a dried rosemary; a dried parsley; a dried thyme; chives; a palm oil; a maltodextrin; a garlic powder; a paprika; crushed chili peppers; a sunflower oil; a dried spinach; a turmeric; the like, and any various combinations thereof. Wherein, the tetrahydrocannabinol and the additional ingredients may be in the grinded up form to create the disclosed seasoning blend. In select possibly preferred embodiments, the additional ingredients used in the disclosed seasoning blend beyond the tetrahydrocannabinol may include: the petrified onions; the salt; the corn starch; the sugar; the monosodium glutamate; the dried basil; the dried oregano; the dried rosemary; the dried parsley; the dried thyme; the chives; the palm oil; the maltodextrin; the garlic powder; the paprika; the crushed chili pepper; the sunflower oil; the dried spinach; and the turmeric.

In select embodiments, the disclosed seasoning blend may include: the tetrahydrocannabinol is between 1% and 25% of a total weight of the seasoning blend; the petrified onions are between 5% and 15% of the total weight of the seasoning blend; the salt is between 10% and 20% of the total weight of the seasoning blend; the corn starch is between 1% and 5% of the total weight of the seasoning blend; the sugar is between 1% and 10% of the total weight of the seasoning blend; the monosodium glutamate is between 1% and 10% of the total weight of the seasoning blend; the dried basil is between 0.25% and 5% of the total weight of the seasoning blend; the dried oregano is between 1% and 10% of the total weight of the seasoning blend; the dried rosemary is between 1% and 5% of the total weight of the seasoning blend; the dried parsley is between 0.25% and 5% of the total weight of the seasoning blend; the dried thyme is between 0.01% and 2% of the total weight of the seasoning blend; the chive is between 0.01% and 2% of the total weight of the seasoning blend; the palm oil is between 0.25% and 5% of the total weight of the seasoning blend; the maltodextrin is between 1% and 5% of the total weight of the seasoning blend; the garlic powder is between 1% and 10% of the total weight of the seasoning blend; the paprika is between 1% and 10% of the total weight of the seasoning blend; the crushed chili pepper is between 1% and 10% of the total weight of the seasoning blend; the sunflower oil is between 0.25% and 5% of the total weight of the seasoning blend; the dried spinach is between 1% and 5% of the total weight of the seasoning blend; and the turmeric is between 1% and 25% of the total weight of the seasoning blend.

In select possibly preferred embodiments, the disclosed seasoning blend may include: the tetrahydrocannabinol is approximately 11% of the total weight of the seasoning blend; the petrified onions are approximately 10% of a total weight of the seasoning blend; the salt is approximately 15% of the total weight of the seasoning blend; the corn starch is approximately 3% of the total weight of the seasoning blend; the sugar is approximately 4% of the total weight of the seasoning blend; the monosodium glutamate is approximately 4% of the total weight of the seasoning blend; the dried basil is approximately 1% of the total weight of the seasoning blend; the dried oregano is approximately 4% of the total weight of the seasoning blend; the dried rosemary is approximately 2% of the total weight of the seasoning blend; the dried parsley is approximately 1% of the total weight of the seasoning blend; the dried thyme is approximately 0.5% of the total weight of the seasoning blend; the chive is approximately 0.1% of the total weight of the seasoning blend; the palm oil is approximately 2% of the total weight of the seasoning blend; the maltodextrin is approximately 2% of the total weight of the seasoning blend; the garlic powder is approximately 7% of the total weight of the seasoning blend; the paprika is approximately 5% of the total weight of the seasoning blend; the crushed chili pepper is approximately 5% of the total weight of the seasoning blend; the sunflower oil is approximately 2% of the total weight of the seasoning blend; the dried spinach is approximately 2% of the total weight of the seasoning blend; and the turmeric is approximately 20% of the total weight of the seasoning blend.

One feature of the disclosed seasoning blend containing tetrahydrocannabinol may be that the tetrahydrocannabinol and the additional ingredients of the seasoning blend may be prepared with a food grinder to create the grinded up form for the seasoning blend.

Another feature of the disclosed seasoning blend containing tetrahydrocannabinol may be that the tetrahydrocannabinol and the additional ingredients of the seasoning blend may be stored in a plastic seasoning container configured to hold 1 to 3 ounces. In select possibly preferred embodiments, the seasoning blend may be stored in a plastic seasoning container configured to hold 1 ounce.

Another feature of the disclosed seasoning blend containing tetrahydrocannabinol may be that it can be designed and configured to reduce the content of common salt or sodium chloride used in foods, food ingredients, or food products.

Another feature of the disclosed seasoning blend containing tetrahydrocannabinol may be that it can be designed and configured to reduce stress.

Another feature of the disclosed seasoning blend containing tetrahydrocannabinol may be that it can be designed and configured to encourage healthy sleep without use of sleeping aids or over the counter drugs.

Another feature of the disclosed seasoning blend containing tetrahydrocannabinol may be that it can be designed and configured to reduce stress and encourage healthy sleep without use of sleeping aids or over the counter drugs.

In another aspect, the instant disclosure embraces embodiments of the disclosed seasoning blend that consist essentially of tetrahydrocannabinol and additional ingredients. Wherein the additional ingredients include: petrified onions; a salt; a corn starch; a sugar; a monosodium glutamate; a dried basil; a dried oregano; a dried rosemary; a dried parsley; a dried thyme; chives; a palm oil; a maltodextrin; a garlic powder; a paprika; crushed chili peppers; a sunflower oil; a dried spinach; a turmeric; the like; and/or various combinations thereof. Wherein the tetrahydrocannabinol and the additional ingredients are in a grinded up form. Wherein the tetrahydrocannabinol may be a legalized synthetic form of delta-8 tetrahydrocannabinol in the grinded up form. In select embodiments, the legalized synthetic form of the delta-8 tetrahydrocannabinol may be dronabinol in the grinded up form. In select embodiments, the disclosed seasoning blend consists essentially of: the legalized synthetic form of the delta-8 tetrahydrocannabinol; the petrified onions; the salt; the corn starch; the sugar; the monosodium glutamate; the dried basil; the dried oregano; the dried rosemary; the dried parsley; the dried thyme; the chives; the palm oil; the maltodextrin; the garlic powder; the paprika; the crushed chili peppers; the sunflower oil; the dried spinach; and the turmeric.

In select embodiments, the disclosed seasoning blend consists essentially of: the tetrahydrocannabinol is between 1% and 25% of a total weight of the seasoning blend; the petrified onions are between 5% and 15% of the total weight of the seasoning blend; the salt is between 10% and 20% of the total weight of the seasoning blend; the corn starch is between 1% and 5% of the total weight of the seasoning blend; the sugar is between 1% and 10% of the total weight of the seasoning blend; the monosodium glutamate is between 1% and 10% of the total weight of the seasoning blend; the dried basil is between 0.25% and 5% of the total weight of the seasoning blend; the dried oregano is between 1% and 10% of the total weight of the seasoning blend; the dried rosemary is between 1% and 5% of the total weight of the seasoning blend; the dried parsley is between 0.25% and 5% of the total weight of the seasoning blend; the dried thyme is between 0.01% and 2% of the total weight of the seasoning blend; the chive is between 0.01% and 2% of the total weight of the seasoning blend; the palm oil is between 0.25% and 5% of the total weight of the seasoning blend; the maltodextrin is between 1% and 5% of the total weight of the seasoning blend; the garlic powder is between 1% and 10% of the total weight of the seasoning blend; the paprika is between 1% and 10% of the total weight of the seasoning blend; the crushed chili pepper is between 1% and 10% of the total weight of the seasoning blend; the sunflower oil is between 0.25% and 5% of the total weight of the seasoning blend; the dried spinach is between 1% and 5% of the total weight of the seasoning blend; and the turmeric is between 1% and 25% of the total weight of the seasoning blend.

In select possibly preferred embodiments, the disclosed seasoning blend consists essentially of: the tetrahydrocannabinol is approximately 11% of the total weight of the seasoning blend; the petrified onions are approximately 10% of a total weight of the seasoning blend; the salt is approximately 15% of the total weight of the seasoning blend; the corn starch is approximately 3% of the total weight of the seasoning blend; the sugar is approximately 4% of the total weight of the seasoning blend; the monosodium glutamate is approximately 4% of the total weight of the seasoning blend; the dried basil is approximately 1% of the total weight of the seasoning blend; the dried oregano is approximately 4% of the total weight of the seasoning blend; the dried rosemary is approximately 2% of the total weight of the seasoning blend; the dried parsley is approximately 1% of the total weight of the seasoning blend; the dried thyme is approximately 0.5% of the total weight of the seasoning blend; the chive is approximately 0.1% of the total weight of the seasoning blend; the palm oil is approximately 2% of the total weight of the seasoning blend; the maltodextrin is approximately 2% of the total weight of the seasoning blend; the garlic powder is approximately 7% of the total weight of the seasoning blend; the paprika is approximately 5% of the total weight of the seasoning blend; the crushed chili pepper is approximately 5% of the total weight of the seasoning blend; the sunflower oil is approximately 2% of the total weight of the seasoning blend; the dried spinach is approximately 2% of the total weight of the seasoning blend; and the turmeric is approximately 20% of the total weight of the seasoning blend.

In another aspect, the instant disclosure embraces embodiments of the disclosed seasoning blend that consists of tetrahydrocannabinol and additional ingredients. Wherein the additional ingredients include: petrified onions; a salt; a corn starch; a sugar; a monosodium glutamate; a dried basil; a dried oregano; a dried rosemary; a dried parsley; a dried thyme; chives; a palm oil; a maltodextrin; a garlic powder; a paprika; crushed chili peppers; a sunflower oil; a dried spinach; a turmeric; the like; and/or various combinations thereof. Wherein the tetrahydrocannabinol and the additional ingredients are in a grinded up form. Wherein the tetrahydrocannabinol may be a legalized synthetic form of delta-8 tetrahydrocannabinol in the grinded up form. In select embodiments, the legalized synthetic form of the delta-8 tetrahydrocannabinol may be dronabinol in the grinded up form. In select embodiments, the disclosed seasoning blend consists of: the legalized synthetic form of the delta-8 tetrahydrocannabinol; the petrified onions; the salt; the corn starch; the sugar; the monosodium glutamate; the dried basil; the dried oregano; the dried rosemary; the dried parsley; the dried thyme; the chives; the palm oil; the maltodextrin; the garlic powder; the paprika; the crushed chili peppers; the sunflower oil; the dried spinach; and the turmeric, all in the grinded up form.

In select embodiments, the disclosed seasoning blend consists of: the tetrahydrocannabinol is between 1% and 25% of a total weight of the seasoning blend; the petrified onions are between 5% and 15% of the total weight of the seasoning blend; the salt is between 10% and 20% of the total weight of the seasoning blend; the corn starch is between 1% and 5% of the total weight of the seasoning blend; the sugar is between 1% and 10% of the total weight of the seasoning blend; the monosodium glutamate is between 1% and 10% of the total weight of the seasoning blend; the dried basil is between 0.25% and 5% of the total weight of the seasoning blend; the dried oregano is between 1% and 10% of the total weight of the seasoning blend; the dried rosemary is between 1% and 5% of the total weight of the seasoning blend; the dried parsley is between 0.25% and 5% of the total weight of the seasoning blend; the dried thyme is between 0.01% and 2% of the total weight of the seasoning blend; the chive is between 0.01% and 2% of the total weight of the seasoning blend; the palm oil is between 0.25% and 5% of the total weight of the seasoning blend; the maltodextrin is between 1% and 5% of the total weight of the seasoning blend; the garlic powder is between 1% and 10% of the total weight of the seasoning blend; the paprika is between 1% and 10% of the total weight of the seasoning blend; the crushed chili pepper is between 1% and 10% of the total weight of the seasoning blend; the sunflower oil is between 0.25% and 5% of the total weight of the seasoning blend; the dried spinach is between 1% and 5% of the total weight of the seasoning blend; and the turmeric is between 1% and 25% of the total weight of the seasoning blend.

In select possibly preferred embodiments, the disclosed seasoning blend consists of: the tetrahydrocannabinol is approximately 11% of the total weight of the seasoning blend; the petrified onions are approximately 10% of a total weight of the seasoning blend; the salt is approximately 15% of the total weight of the seasoning blend; the corn starch is approximately 3% of the total weight of the seasoning blend; the sugar is approximately 4% of the total weight of the seasoning blend; the monosodium glutamate is approximately 4% of the total weight of the seasoning blend; the dried basil is approximately 1% of the total weight of the seasoning blend; the dried oregano is approximately 4% of the total weight of the seasoning blend; the dried rosemary is approximately 2% of the total weight of the seasoning blend; the dried parsley is approximately 1% of the total weight of the seasoning blend; the dried thyme is approximately 0.5% of the total weight of the seasoning blend; the chive is approximately 0.1% of the total weight of the seasoning blend; the palm oil is approximately 2% of the total weight of the seasoning blend; the maltodextrin is approximately 2% of the total weight of the seasoning blend; the garlic powder is approximately 7% of the total weight of the seasoning blend; the paprika is approximately 5% of the total weight of the seasoning blend; the crushed chili pepper is approximately 5% of the total weight of the seasoning blend; the sunflower oil is approximately 2% of the total weight of the seasoning blend; the dried spinach is approximately 2% of the total weight of the seasoning blend; and the turmeric is approximately 20% of the total weight of the seasoning blend.

### EXAMPLE

A seasoning blend was created with a cannabis flower containing THC. The seasoning blend was created from:
1 full oz of dried, cured cannabis flower=approximately 15.63 grams
1 oz petrified onions=approximately 13.8 grams
3 tablespoons salt=approximately 21.6 grams
½ tablespoon corn starch=approximately 4 grams
2 tablespoons sugar=approximately 6.25 grams
½ tablespoon monosodium glutamate=approximately 6 grams
1 tablespoon dried basil=approximately 2.1 grams
1 tablespoon dried oregano=approximately 5.4 grams
1 tablespoon dried rosemary=approximately 3.3 grams
1 tablespoon dried parsley=approximately 1.6 grams
½ teaspoon dried thyme=approximately 0.72 grams
1 tablespoon chives=approximately 0.2 grams
½ teaspoon palm oil=approximately 2.25 grams
½ teaspoon maltodextrin=approximately 2.46 grams
1 tablespoon garlic powder=approximately 9.7 grams
1 tablespoon paprika=approximately 6.8 grams
2 tablespoons crushed chili pepper=approximately 6.6 grams
½ teaspoon sunflower oil=approximately 2.27 grams
2 tablespoons dried spinach=approximately 2.5 grams
3 tablespoons turmeric=approximately 28.2 grams

These ingredients were put into a grinder and ground into the grinded up form of all ingredients and thoroughly mixed together. This resulted in approximately 23.5 fluid ounces of seasoning blend weighing approximately 141.38 grams. This was divided approximately into 24 equal parts that were each put into 1 oz. plastic seasoning containers. This resulted in 24 1 oz. bottles of seasoning mix containing approximately 12 grams of seasoning blend.

The dried and cured cannabis flower used was tested according to testing method HPLC, CON-P-3000. The test results showed that the dried and cured cannabis flower included approximately 20.4% total cannabinoids, or equal to 20.4% or 20.376%. Of these total cannabinoids in the dried and cured cannabis flower, approximately 0.5% total was found to be tetrahydrocannabinol, or equal to 0.5% or 0.493%. The dried and cured cannabis flower was found to include: less than the limit of quantitation percentage of delta-9 tetrahydrocannabinol; 0.562% mass of delta-9 tetrahydrocannabinolic acid; less than a limit of quantitation percentage of cannabidivannic acid; 0.991% mass of cannabidiol; 17.617% mass of cannabidiolic acid; 0.310% mass of cannabigerolic acid; 0.075% mass of cannabichromene; and 0.819% mass of cannabichromenic acid. In addition, the dried and cured cannabis flower was tested to have lower than a limit of detection of: delta-8 tetrahydrocannabinol; delta-9 tetrahydrocannabiphorol; delta-9 tetrahydrocannabivarin; delta-9 tetrahydrocannabivarinic acid; R-delta-10 tetrahydrocannabinol; S-delta-10 tetrahydrocannabinol; 9R-hexahydrocannbinol; 9S-hexahydrocannbinol; tetrahydrocannabinol acetate; cannabidavarin; cannabigerol; cannabinol; and cannabinolic acid. Wherein, the limit of quantitation percentage was 0.0714% and the limit of detection was 0.0476%. The dried and cured cannabis flower was a dried and cured sour candy kush plant.

In sum, the present disclosure may relate to a seasoning blend, a seasoning mixture and a method of seasoning a food ingredient and/or a food product with tetrahydrocannabinol or THC. Particularly, the present disclosure may relate to a seasoning blend and/or a seasoning mixture that contains a delta-8 tetrahydrocannabinol, a delta-9 tetrahydrocannabinol, a delta-10 tetrahydrocannabinol, or a combination thereof, like a legalized synthetic form of a delta-8 tetrahydrocannabinol, a delta-9 tetrahydrocannabinol, a delta-10 tetrahydrocannabinol, or a combination thereof. The present disclosure may also relate to a method of seasoning a food ingredient and/or a food product with the seasoning blend and/or mixture containing tetrahydrocannabinol or THC. Further, the present disclosure may relate to a use of tetrahydrocannabinol or THC, delta-8 tetrahydrocannabinol or delta-8 THC, delta-9 tetrahydrocannabinol or delta-9 THC, delta-10 tetrahydrocannabinol or delta-10 TCH, or combinations thereof, in a seasoning blend for reducing the content of common salt or sodium chloride in a food ingredient and/or a food product. In addition, the present disclosure may relate to a use of tetrahydrocannabinol or THC, delta-8 tetrahydrocannabinol or delta-8 THC, delta-9 tetrahydrocannabinol or delta-9 THC, delta-10 tetrahydrocannabinol or delta-10 TCH, or combinations thereof, in a seasoning blend configured to reduce stress and encourage a healthy sleep without use of sleeping aids, i.e. over the counter sleeping aids, drugs or medicines. As such, the disclosed seasoning blend with tetrahydrocannabinol or THC, like delta-8 tetrahydrocannabinol or delta-8 THC, delta-9 tetrahydrocannabinol or delta-9 THC, delta-10 tetrahydrocannabinol or delta-10 TCH, or combinations thereof, may be directed to aid in healthy sleeping habits while reducing salt intake and reducing stress.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A seasoning blend comprising:
a tetrahydrocannabinol, wherein the tetrahydrocannabinol is in a grinded up form.

2. The seasoning blend according to claim 1, wherein the tetrahydrocannabinol is a legalized synthetic form of a delta-8 tetrahydrocannabinol, a delta-9 tetrahydrocannabinol, a delta-10 tetrahydrocannabinol, or a combination thereof, in the grinded up form.

3. The seasoning blend according to claim 2, wherein the legalized synthetic form of the delta-8 tetrahydrocannabinol, a delta-9 tetrahydrocannabinol, a delta-10 tetrahydrocannabinol, or the combination thereof, is dronabinol in the grinded up form.

4. The seasoning blend according to claim 1, wherein the tetrahydrocannabinol in the grinded up form is derived from a cannabis flower, the cannabis flower including:
approximately 20.4% total cannabinoids, including:
approximately 0.5% total tetrahydrocannabinol.

5. The seasoning blend according to claim 4, wherein the cannabis flower including:
less than the limit of quantitation percentage of delta-9 tetrahydrocannabinol;
0.562% mass of delta-9 tetrahydrocannabinolic acid;
less than a limit of quantitation percentage of cannabidivannic acid;
0.991% mass of cannabidiol;
17.617% mass of cannabidiolic acid;
0.310% mass of cannabigerolic acid;
0.075% mass of cannabichromene; and
0.819% mass of cannabichromenic acid;
lower than a limit of detection of:
delta-8 tetrahydrocannabinol;
delta-9 tetrahydrocannabiphorol;
delta-9 tetrahydrocannabivarin;
delta-9 tetrahydrocannabivarinic acid;
R-delta-10 tetrahydrocannabinol;
S-delta-10 tetrahydrocannabinol;
9R-hexahydrocannbinol;
9 S-hexahydrocannbinol;
tetrahydrocannabinol acetate;
cannabidavarin;
cannabigerol;
cannabinol; and
cannabinolic acid;
wherein, the limit of quantitation percentage being 0.0714% and the limit of detection being 0.0476%.

6. The seasoning blend according to claim 1, wherein the tetrahydrocannabinol in the grinded up form is between 1% and 25% of the total weight of the seasoning blend.

7. The seasoning blend according to claim 6, wherein the tetrahydrocannabinol in the grinded up form is between 10% and 15% of the total weight of the seasoning blend.

8. The seasoning blend according to claim 7, wherein the tetrahydrocannabinol in the grinded up form is approximately 11% of the total weight of the seasoning blend.

9. The seasoning blend according to claim 1 further comprising additional ingredients, wherein the additional ingredients include:
petrified onions;
a salt;
a corn starch;
a sugar;
a monosodium glutamate;
a dried basil;
a dried oregano;
a dried rosemary;
a dried parsley;
a dried thyme;
chives;
a palm oil;
a maltodextrin;
a garlic powder;
a paprika;
crushed chili peppers;
a sunflower oil;
a dried spinach;
a turmeric; or
combinations thereof; and
wherein, the tetrahydrocannabinol and the additional ingredients are in the grinded up form.

10. The seasoning blend according to claim 9, wherein the additional ingredients include:
the petrified onions;
the salt;
the corn starch;
the sugar;
the monosodium glutamate;
the dried basil;
the dried oregano;
the dried rosemary;
the dried parsley;
the dried thyme;
the chives;
the palm oil;
the maltodextrin;
the garlic powder;
the paprika;
the crushed chili pepper;
the sunflower oil;
the dried spinach; and
the turmeric;
wherein:
the tetrahydrocannabinol is between 1% and 25% of a total weight of the seasoning blend;
the petrified onions are between 5% and 15% of the total weight of the seasoning blend;
the salt is between 10% and 20% of the total weight of the seasoning blend;
the corn starch is between 1% and 5% of the total weight of the seasoning blend;
the sugar is between 1% and 10% of the total weight of the seasoning blend;
the monosodium glutamate is between 1% and 10% of the total weight of the seasoning blend;
the dried basil is between 0.25% and 5% of the total weight of the seasoning blend;
the dried oregano is between 1% and 10% of the total weight of the seasoning blend;
the dried rosemary is between 1% and 5% of the total weight of the seasoning blend;
the dried parsley is between 0.25% and 5% of the total weight of the seasoning blend;
the dried thyme is between 0.01% and 2% of the total weight of the seasoning blend;
the chive is between 0.01% and 2% of the total weight of the seasoning blend;
the palm oil is between 0.25% and 5% of the total weight of the seasoning blend;
the maltodextrin is between 1% and 5% of the total weight of the seasoning blend;
the garlic powder is between 1% and 10% of the total weight of the seasoning blend;
the paprika is between 1% and 10% of the total weight of the seasoning blend;
the crushed chili pepper is between 1% and 10% of the total weight of the seasoning blend;
the sunflower oil is between 0.25% and 5% of the total weight of the seasoning blend;
the dried spinach is between 1% and 5% of the total weight of the seasoning blend; and
the turmeric is between 1% and 25% of the total weight of the seasoning blend.

11. The seasoning blend according to claim 10, wherein:
the tetrahydrocannabinol is approximately 11% of the total weight of the seasoning blend;
the petrified onions are approximately 10% of the total weight of the seasoning blend;
the salt is approximately 15% of the total weight of the seasoning blend;
the corn starch is approximately 3% of the total weight of the seasoning blend;
the sugar is approximately 4% of the total weight of the seasoning blend;
the monosodium glutamate is approximately 4% of the total weight of the seasoning blend;
the dried basil is approximately 1% of the total weight of the seasoning blend;
the dried oregano is approximately 4% of the total weight of the seasoning blend;
the dried rosemary is approximately 2% of the total weight of the seasoning blend;
the dried parsley is approximately 1% of the total weight of the seasoning blend;
the dried thyme is approximately 0.5% of the total weight of the seasoning blend;
the chive is approximately 0.1% of the total weight of the seasoning blend;
the palm oil is approximately 2% of the total weight of the seasoning blend;
the maltodextrin is approximately 2% of the total weight of the seasoning blend;
the garlic powder is approximately 7% of the total weight of the seasoning blend;
the paprika is approximately 5% of the total weight of the seasoning blend;
the crushed chili pepper is approximately 5% of the total weight of the seasoning blend;
the sunflower oil is approximately 2% of the total weight of the seasoning blend;
the dried spinach is approximately 2% of the total weight of the seasoning blend; and
the turmeric is approximately 20% of the total weight of the seasoning blend.

12. The seasoning blend according to claim 8, wherein the tetrahydrocannabinol and the additional ingredients of the seasoning blend are prepared with a food grinder to create the grinded up form for the seasoning blend.

13. The seasoning blend according to claim 1, wherein the tetrahydrocannabinol and additional ingredients of the seasoning blend are stored in a plastic seasoning container configured to hold 1 to 3 ounces.

14. The seasoning blend according to claim 1 being designed and configured to:
reduce the content of a common salt or sodium chloride used in foods, food ingredients, or food products;
reduce stress and encourage healthy sleep without use of sleeping aids or over the counter drugs; or
a combination thereof.

15. A seasoning blend consisting essentially of:
a tetrahydrocannabinol;
additional ingredients, wherein the additional ingredients include:
petrified onions;
a salt;
a corn starch;
a sugar;
a monosodium glutamate;
a dried basil;
a dried oregano;
a dried rosemary;
a dried parsley;
a dried thyme;
chives;
a palm oil;
a maltodextrin;
a garlic powder;
a paprika;
crushed chili peppers;
a sunflower oil;
a dried spinach;
a turmeric; or
combinations thereof; and
wherein the tetrahydrocannabinol and the additional ingredients are in a grinded up form.

16. The seasoning blend according to claim 15, wherein the tetrahydrocannabinol is a legalized synthetic form of a delta-8 tetrahydrocannabinol, a delta-9 tetrahydrocannabinol, a delta-10 tetrahydrocannabinol, or a combination thereof, in the grinded up form, wherein the legalized synthetic form is dronabinol in the grinded up form.

17. The seasoning blend according to claim 16, wherein the additional ingredients include:
the petrified onions;
the salt;
the corn starch;
the sugar;
the monosodium glutamate;
the dried basil;
the dried oregano;
the dried rosemary;
the dried parsley;
the dried thyme;
the chives;
the palm oil;
the maltodextrin;
the garlic powder;
the paprika;
the crushed chili pepper;
the sunflower oil;
the dried spinach; and
the turmeric
wherein:
the legalized synthetic form of the delta-8 tetrahydrocannabinol is between 1% and 25% of a total weight of the seasoning blend;
the petrified onions are between 5% and 15% of the total weight of the seasoning blend;
the salt is between 10% and 20% of the total weight of the seasoning blend;
the corn starch is between 1% and 5% of the total weight of the seasoning blend;
the sugar is between 1% and 10% of the total weight of the seasoning blend;
the monosodium glutamate is between 1% and 10% of the total weight of the seasoning blend;
the dried basil is between 0.25% and 5% of the total weight of the seasoning blend;
the dried oregano is between 1% and 10% of the total weight of the seasoning blend;
the dried rosemary is between 1% and 5% of the total weight of the seasoning blend;
the dried parsley is between 0.25% and 5% of the total weight of the seasoning blend;
the dried thyme is between 0.01% and 2% of the total weight of the seasoning blend;
the chive is between 0.01% and 2% of the total weight of the seasoning blend;
the palm oil is between 0.25% and 5% of the total weight of the seasoning blend;
the maltodextrin is between 1% and 5% of the total weight of the seasoning blend;
the garlic powder is between 1% and 10% of the total weight of the seasoning blend;
the paprika is between 1% and 10% of the total weight of the seasoning blend;
the crushed chili pepper is between 1% and 10% of the total weight of the seasoning blend;
the sunflower oil is between 0.25% and 5% of the total weight of the seasoning blend;
the dried spinach is between 1% and 5% of the total weight of the seasoning blend; and
the turmeric is between 1% and 25% of the total weight of the seasoning blend.

18. The seasoning blend according to claim 17, wherein:
the legalized synthetic form of the delta-8 tetrahydrocannabinol is approximately 11% of the total weight of the seasoning blend;
the petrified onions are approximately 10% of the total weight of the seasoning blend;
the salt is approximately 15% of the total weight of the seasoning blend;
the corn starch is approximately 3% of the total weight of the seasoning blend;
the sugar is approximately 4% of the total weight of the seasoning blend;
the monosodium glutamate is approximately 4% of the total weight of the seasoning blend;
the dried basil is approximately 1% of the total weight of the seasoning blend;
the dried oregano is approximately 4% of the total weight of the seasoning blend;
the dried rosemary is approximately 2% of the total weight of the seasoning blend;
the dried parsley is approximately 1% of the total weight of the seasoning blend;
the dried thyme is approximately 0.5% of the total weight of the seasoning blend;
the chive is approximately 0.1% of the total weight of the seasoning blend;
the palm oil is approximately 2% of the total weight of the seasoning blend;
the maltodextrin is approximately 2% of the total weight of the seasoning blend;
the garlic powder is approximately 7% of the total weight of the seasoning blend;
the paprika is approximately 5% of the total weight of the seasoning blend;
the crushed chili pepper is approximately 5% of the total weight of the seasoning blend;
the sunflower oil is approximately 2% of the total weight of the seasoning blend;
the dried spinach is approximately 2% of the total weight of the seasoning blend; and
the turmeric is approximately 20% of the total weight of the seasoning blend.

19. A seasoning blend consisting of:
a legalized synthetic form of a delta-8 tetrahydrocannabinol, a delta-9 tetrahydrocannabinol, a delta-10 tetrahydrocannabinol, or a combination thereof; and
additional ingredients, wherein the additional ingredients include:
petrified onions;
a salt;
a corn starch;
a sugar;
a monosodium glutamate;
a dried basil;
a dried oregano;
a dried rosemary;
a dried parsley;
a dried thyme;
chives;
a palm oil;
a maltodextrin;
a garlic powder;
a paprika;
crushed chili peppers;
a sunflower oil;
a dried spinach; and
a turmeric;
wherein the legalized synthetic form of the delta-8 tetrahydrocannabinol, the delta-9 tetrahydrocannabinol, the delta-10 tetrahydrocannabinol, or the combination thereof and the additional ingredients are in a grinded up form.

20. The seasoning blend according to claim 19, wherein the legalized synthetic form of the delta-8 tetrahydrocannabinol, the delta-9 tetrahydrocannabinol, the delta-10 tetrahydrocannabinol, or the combination thereof, is dronabinol in the grinded up form;
wherein:
the legalized synthetic form of the delta-8 tetrahydrocannabinol, the delta-9 tetrahydrocannabinol, the delta-10 tetrahydrocannabinol, or the combination thereof, is approximately 11% of the total weight of the seasoning blend;
the petrified onions are approximately 10% of a total weight of the seasoning blend;
the salt is approximately 15% of the total weight of the seasoning blend;
the corn starch is approximately 3% of the total weight of the seasoning blend;
the sugar is approximately 4% of the total weight of the seasoning blend;
the monosodium glutamate is approximately 4% of the total weight of the seasoning blend;
the dried basil is approximately 1% of the total weight of the seasoning blend;
the dried oregano is approximately 4% of the total weight of the seasoning blend;
the dried rosemary is approximately 2% of the total weight of the seasoning blend;
the dried parsley is approximately 1% of the total weight of the seasoning blend;
the dried thyme is approximately 0.5% of the total weight of the seasoning blend;
the chive is approximately 0.1% of the total weight of the seasoning blend;
the palm oil is approximately 2% of the total weight of the seasoning blend;
the maltodextrin is approximately 2% of the total weight of the seasoning blend;
the garlic powder is approximately 7% of the total weight of the seasoning blend;
the paprika is approximately 5% of the total weight of the seasoning blend;
the crushed chili pepper is approximately 5% of the total weight of the seasoning blend;
the sunflower oil is approximately 2% of the total weight of the seasoning blend;
the dried spinach is approximately 2% of the total weight of the seasoning blend; and
the turmeric is approximately 20% of the total weight of the seasoning blend.
